(19) United States
(12) Patent Application Publication
(10) Pub. No.: US 2026/0035048 A1
(43) Pub. Date: Feb. 5, 2026

(54) ILLUMINATION SYSTEMS FOR PERSONAL TRANSPORT DEVICE

(71) Applicant: Honda Motor Co., Ltd., Tokyo (JP)

(72) Inventors: Victor Eric ACUÑA, Torrance, CA (US); Dillon KANE, Torrance, CA (US); Geemay CHIA, Pasadena, CA (US); Ju Chia LEE, Pasadena, CA (US)

(21) Appl. No.: 18/793,534

(22) Filed: Aug. 2, 2024

(51) Int. Cl. B62J 6/025; B62J 6/026

(52) U.S. Cl. CPC B62J 6/025; B62J 6/026

(57) ABSTRACT

The present disclosure relates to illumination systems and devices for a personal transport device. More particularly, this disclosure describes an attachment for the personal transport device that modifies or adjusts light from a light source on the personal transport device. The light source may be positioned within the personal transport device for dispensing light. Without the attachment, the light from the light source is projected in a forward direction. With the attachment, however, the direction of the light may be modified or adjusted to be pointed in a direction and width for a specific driving scenario.

### BACKGROUND

In the last decade, many people have turned to other forms of transportation such as, for example, mopeds, bicycles, kickboards and, more recently, compact personal transport devices, such as electric scooters. These personal transport devices may be particularly popular for shorter trips in a city environment due to their compact size, ease of use, mobility, and the fact that they may be folded as needed for ease of portability. They may also be useful for covering the first mile or last mile of a trip which is the link between a user's origin or destination and another transportation means, hub or mass transit network.

Current lighting systems for these devices may be inadequate. For example, and during evenings, uneven concrete or potholes may cause hazardous situations for a user of the personal transport device. The present disclosure provides for illumination systems for personal transport devices that overcome these challenges. Other benefits and advantages will become clear from the disclosure provided herein and those advantages provided are for illustration. The statements in this section merely provide the background related to the present disclosure and does not constitute prior art.

### BRIEF DESCRIPTION

This summary is provided to introduce a selection of concepts in a simplified form that are further described below in the DESCRIPTION OF THE DISCLOSURE. This summary is not intended to identify key features of the claimed subject matter, nor is it intended to be used as an aid in determining the scope of the claimed subject matter.

In accordance with one aspect of the present disclosure, a personal transport device is provided. The device may include a casing, a front wheel, a rear wheel, a steering assembly, a light source positioned within the casing for dispensing light, and an attachment for the light source that modifies an original direction of the light.

In accordance with another aspect of the present disclosure, an attachment for a light source on a personal transport device is provided. The attachment may include a circular lens and a plurality of slats atop the circular lens for redirecting light from the light source into a downwards angle.

In accordance with yet another aspect of the present disclosure, a system is provided. The system may include a personal transport device and an illumination system disposed within the personal transport device having a light source and an attachment for the light source, the attachment modifying a direction of light coming from the light source.

### BRIEF DESCRIPTION OF DRAWINGS

The novel features believed to be characteristic of the disclosure are set forth in the appended claims. In the descriptions that follow, like parts are marked throughout the specification and drawings with the same numerals, respectively. The drawing FIGURES are not necessarily drawn to scale and certain FIGURES may be shown in exaggerated or generalized form in the interest of clarity and conciseness. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a front side view of an illustrative personal transport device in accordance with one aspect of the present disclosure;

FIG. 2 is a back side view of the illustrative personal transport device in accordance with one aspect of the present disclosure;

FIG. 3 is a top view of the illustrative personal transport device in accordance with one aspect of the present disclosure;

FIG. 4 is a top view of an exemplary control system for the illustrative personal transport device in accordance with one aspect of the present disclosure;

FIG. 5 is a view of exemplary components within the illustrative personal transport device in accordance with one aspect of the present disclosure;

FIG. 6 is a view of an exemplary lighting system for the illustrative personal transport device in accordance with one aspect of the present disclosure;

FIG. 7 is a view of the exemplary lighting system angled downward for the illustrative personal transport device in accordance with one aspect of the present disclosure;

FIG. 8 is a view of the exemplary lighting system with a conical projection facing forward for the illustrative personal transport device in accordance with one aspect of the present disclosure;

FIG. 9 is a view of the exemplary lighting system with the conical projection facing downwards for the illustrative personal transport device in accordance with one aspect of the present disclosure;

FIG. 10 is an exemplary lighting system which has been altered with the use of an attachment for the illustrative personal transport device in accordance with one aspect of the present disclosure;

FIG. 11 is the illustrative personal transport device showing an inlet for exchanging out different lighting systems in accordance with one aspect of the present disclosure;

FIG. 12 is an exemplary attachment showing slats used for directing light in accordance with one aspect of the present disclosure;

FIG. 13 is another embodiment of an attachment to direct light for the illustrative personal transport device in accordance with one aspect of the present disclosure;

FIG. 14 is an embodiment for actuating the attachment for the illustrative personal transport device in accordance with one aspect of the present disclosure;

FIG. 15 is an embodiment for altering light in a downward direction using the attachment for the illustrative personal transport device in accordance with one aspect of the present disclosure;

FIG. 16 is an embodiment for altering light in a wider downward direction using the attachment for the illustrative personal transport device in accordance with one aspect of the present disclosure;

FIG. 17 is an embodiment for altering light in a forward and downward direction using the attachment for the illustrative personal transport device in accordance with one aspect of the present disclosure;

FIG. 18 is an embodiment for altering light in a downward direction using the attachment for the illustrative personal transport device in accordance with one aspect of the present disclosure;

FIG. 19 is an embodiment for altering light in two downward directions using the attachment for the illustrative personal transport device in accordance with one aspect of the present disclosure.

### DESCRIPTION OF THE DISCLOSURE

The description set forth below in connection with the appended drawings is intended as a description of exemplary embodiments of the disclosure and is not intended to represent the only forms in which the present disclosure may be constructed and/or utilized. The description sets forth the functions and the sequence of blocks for constructing and operating the disclosure in connection with the illustrated embodiments. It is to be understood, however, that the same or equivalent functions and sequences may be accomplished by different embodiments that are also intended to be encompassed within the spirit and scope of this disclosure.

The present disclosure relates to illumination systems and devices for a personal transport device. More particularly, this disclosure describes an attachment for the personal transport device that modifies or adjusts light from a light source on the personal transport device. The light source may be positioned within the personal transport device for dispensing light. Without the attachment, the light from the light source is projected in a forward direction. With the attachment, however, the direction of the light may be modified or adjusted to be pointed in a direction and width for a specific driving scenario.

Numerous other modifications or configurations to the illumination systems and devices for the personal transport device will become apparent from the description provided below. For example, the light source and the attachment may be combined in a singular modular unit. The attachment, in the alternative, may be coupled atop the light source. Advantageously, and by having the attachment, redirected light from the personal transport device may enhance a driving experience of the user. This may include projecting light on uneven concrete or potholes that may cause hazardous situations for a user of the personal transport device. By highlighting hazards, a driver may be able to avoid them. Other advantages will become apparent from the description provided below.

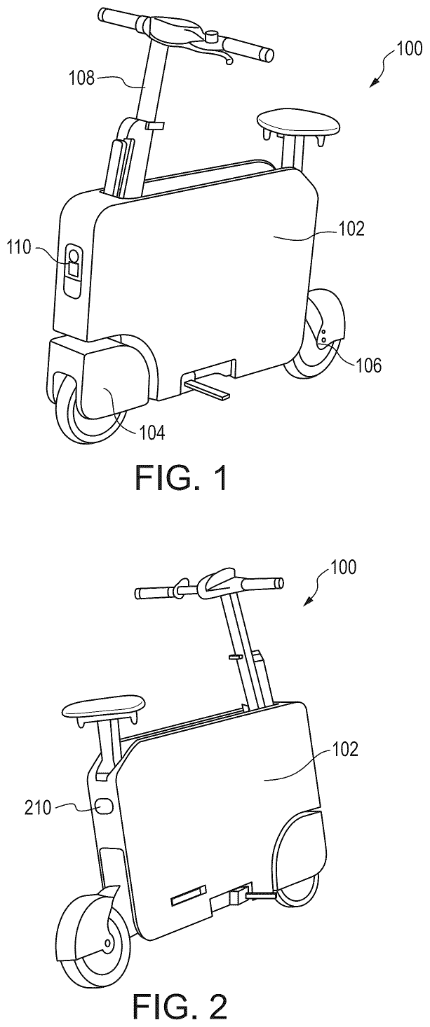

With reference now to FIG. 1, a front side view of an illustrative personal transport device 100 in accordance with one aspect of the present disclosure is provided. The device 100 may be a sit-on scooter as shown. Trucks, trailers, bicycles, scooters, and the like may also include the illumination system described herein. The illumination system may be included as part of the device 100 or may be an attachment which varies dependent on the particular mobility device used.

The personal transport device 100 may include a casing 102. The casing 102 may have a hollowed interior and may store components such as a seat and other mechanisms for the device 100. In a retracted state, multiple components may be fit within the casing 102. The casing 102 may be made of sturdy and rigid materials such as metal, durable plastic, or other compounds. The casing 102 is intended to protect the internal components of the personal transport device 100.

The casing 102 may house a front wheel 104. The front wheel may be movable through a steering column which is connected to a steering assembly 108. The front wheel 104 may be rotated and set within the casing 102. Through movement of the steering assembly 108, the front wheel 104 may be rotated.

The personal transport device 100 may include a rear wheel 106. The rear wheel 106 may be in the back end of the casing 102 of the device 100. The rear wheel 106, in one embodiment, may be moved in and out of the casing 102 to reduce its footprint. The wheel 106 may be dynamically slid into and out of the casing 102 to reduce the entire area of the casing 102.

The steering assembly 108 may also include components that may be used to steer, power, and control the personal transport device 100. In one example, the steering assembly 108 may include a brake system that either prevents or slows the front wheel 104 or rear wheel 106 from moving. In this way, the personal transport device 100 may be slowed or stopped.

In addition to the braking system, the steering assembly 108 may house the acceleration system. This may include a rotating handlebar that is used to increase acceleration based on how much the handlebar is manipulated. The further the handlebar is twisted, the more acceleration is provided. Other acceleration systems may be provided on the assembly 108.

Other logic may be provided through or on top of the steering assembly 108. For example, a speed gauge may be provided that indicates the speed and/or acceleration of the personal transport device 100. If there is an issue with the device 100 then graphical or digital displays may be given. Horns or sirens may be placed on the steering assembly 108.

Control of a front lighting assembly 110 may be also part of the steering assembly 108. This illumination system may be toggled through a button or other device on top of the assembly 110. The front lighting assembly 110, which will be described in further details below, may be used to project or display light from the personal transport device 100. The light without the attachment may be shown in a forward position. With the attachment, the light may be modified from it is original direction as well as its intensity and width.

FIG. 2 is a back side view of the illustrative personal transport device 100 in accordance with one aspect of the present disclosure. A back lighting assembly 210 may be provided on a rear portion of the case 102. The back lighting assembly 210 may be similar to the front lighting assembly described earlier. The illumination system for the front lighting assembly and the back lighting assembly 210 may include a light source and an attachment which will be described in further details below. Both lighting assemblies may be used to project light.

The front lighting assembly may be toggled on or off. Similarly, controls on the steering assembly 108 may be used to turn the back lighting assembly 210 on or off. In one embodiment, the back lighting assembly 210 may be constantly kept on while the user is riding on the personal transport device 100. If the user has powered on the device 100, the back lighting assembly 210 may be turned on.

Both lighting assemblies may include a light source positioned within the casing for projecting light and an attachment for the light source that modifies an original direction of the light. As will be shown below, the lighting assemblies may be wholly removed from the casing 102 and may be interchanged or the attachment within the lighting assemblies may be interchanged. Different assemblies may be stored within the casing such that they are easily exchanged.

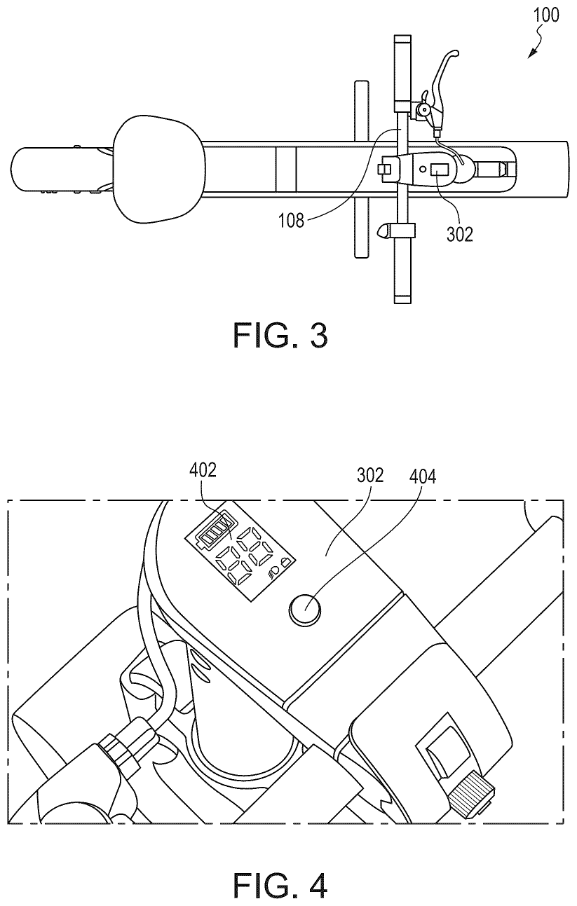

FIG. 3 is a top view of the illustrative personal transport device 100 in accordance with one aspect of the present disclosure. The steering assembly 108 may include a controller 302. The controller 302 will be described further in FIG. 4 with FIG. 4 providing a top view of an exemplary control system for the illustrative personal transport device in accordance with one aspect of the present disclosure. The controller 302 may include a user interface 402. The user interface 402 may include a digital display indicating the speed of the personal transport device. Battery power may also be shown through the user interface 402. Other types of information on the user interface 402 may include maintenance issues, error issues, GPS information, and the like.

A button 404 on the top of the controller 302 may be used to toggle the personal transport device on or off. The button 404 may also be used for different modes for riding the device 102. The modes may relate to speed limits that the personal transport device may exceed.

Beyond those functions described above, the controller 302 may include control logic that may be used to turn on or off the personal transport device 100, accelerate/brake the device 100, and provide other basic functions. Other functions that may be included are related to power management functions. For example, an eco-mode may be used such that the rider may prolong the battery life as much as possible. The control logic may be centralized in the controller 302 or elsewhere in the personal transport device. However, by centralizing the logic into a singular area, maintenance may be much easier, that is, exchanging the controller 302 is simpler than changing the components within the casing of the personal transport device 100.

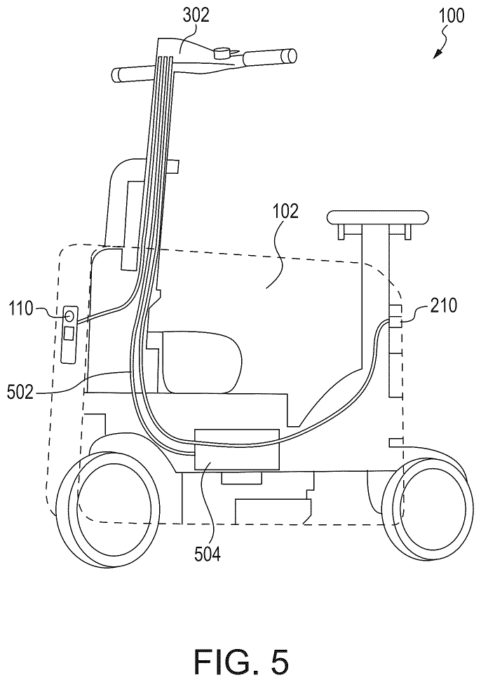

With reference to FIG. 5, a view of exemplary components within the illustrative personal transport device 100 in accordance with one aspect of the present disclosure is provided. A number of different components are within the casing 102 of the personal transport device 100. As described earlier, the controller 302 may be used to accelerate, brake, turn on or off the device 100, and provide functions for the device 100. The controller 302 may be used to turn on or off the front light assembly 110 and the back lighting assembly 210. Through a set of wirings 502, the controller 302 may direct power from the battery 504 to turn on or off the front light assembly 110 or the back lighting assembly 210.

The battery 504 level may be indicated or displayed on the controller 302 as described above. Power may be drawn from the battery 504 to power a motor, braking system and other functions. The motor may be used to draw power from the battery 504 and to drive the wheels for acceleration or propulsion. The wirings 502 may be used to not only provide control but also provide power throughout the personal transport device 100. The wirings 502 may connect the back lighting assembly 210, the front lighting assembly 110, the battery 504, and the controller 302. The wirings 502 may be channeled throughout the casing 102.

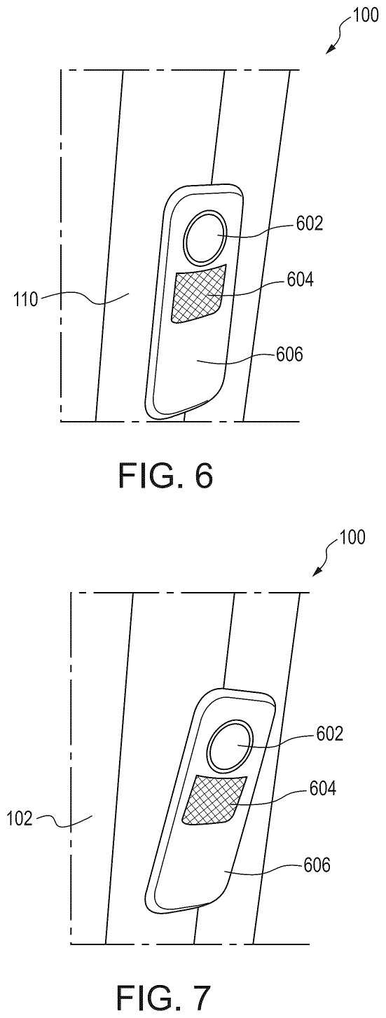

FIG. 6 is a view of an exemplary lighting system for the illustrative personal transport device 100 in accordance with one aspect of the present disclosure. While the front lighting system 110 is shown, the back lighting system may operate in a similar fashion. The front lighting assembly 110 may include a light source 602 and reflector 604. These may be included on a singular modular unit 606 which may be replaceable, that is, the unit 606 may include different attachments.

In one example, the singular modular unit 606 may include different colored lights, patterns, and textures. The attachment, which will be described below, may modify the direction and possibly the intensity of the light being projected from the personal transport device 100.

FIG. 7 is a view of the exemplary lighting system angled downward for the illustrative personal transport device 100 in accordance with one aspect of the present disclosure. The singular modular unit 606 may be pivoted downwards or upwards thus changing the direction of the light source 602 and the reflector 604. A swivel mechanism within the personal transport device 100 may be within the casing 102.

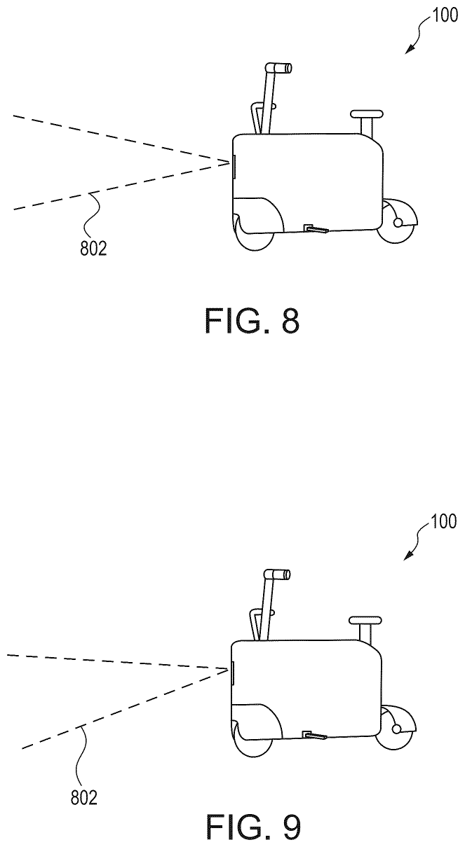

With reference to FIG. 8, a view of the exemplary lighting system with a conical projection 802 facing forward for the illustrative personal transport device 100 in accordance with one aspect of the present disclosure is provided. This involves a typical situation where the light is projected forward and no attachment has been used. FIG. 9 is a view of the exemplary lighting system with the conical projection 802 facing downwards for the illustrative personal transport device 100 in accordance with one aspect of the present disclosure. The user may pivot the singular modular unit to place the projection 802 downwards. Noticeably, the difference between the two is that the projection 802 may highlight different aspects of their environment. This may apply to the front lighting system or the back light system.

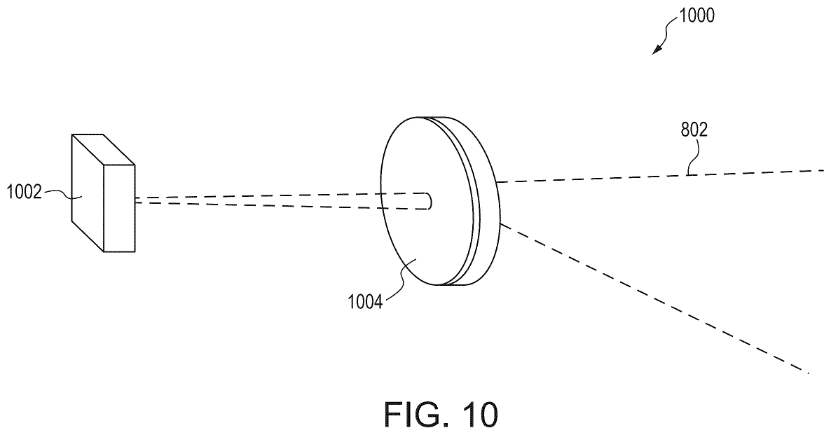

FIG. 10 is an exemplary lighting system 1000 which has been altered with the use of the attachment 1004 for the illustrative personal transport device in accordance with one aspect of the present disclosure. The lighting system 1000 may include a light source 1002. The light source 1002 may provide light to the attachment 1004. The attachment 1004 may alter or modify the light from the light source 1002. The attachment 1004 may alter or adjust the light coming from the beam of light to an intended direction by the user. For example, the beam of light may be altered by widening it. In another example, the beam of light be provided in a downward direction. Multiple different types of alterations or modifications may be actuated through the user of the attachment 1004.

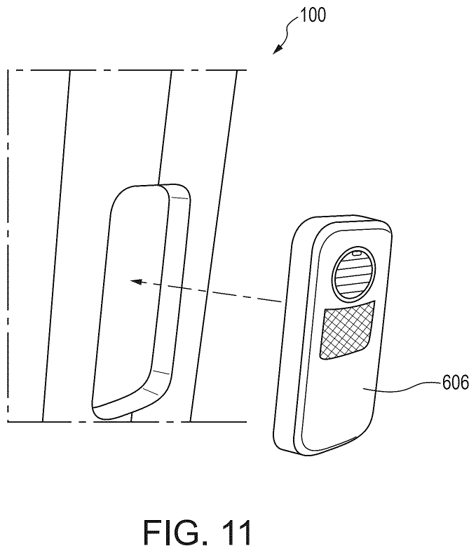

FIG. 11 is the illustrative personal transport device 100 showing an inlet for exchanging out different lighting systems in accordance with one aspect of the present disclosure. The singular modular unit 606, as shown, may be exchanged into and out of a socket within the personal transport deice 100. The modular unit 606 may be placed or tied into the device 100 through a clasp, or other attachment method that would securely fit the modular unit 606 into the device 100.

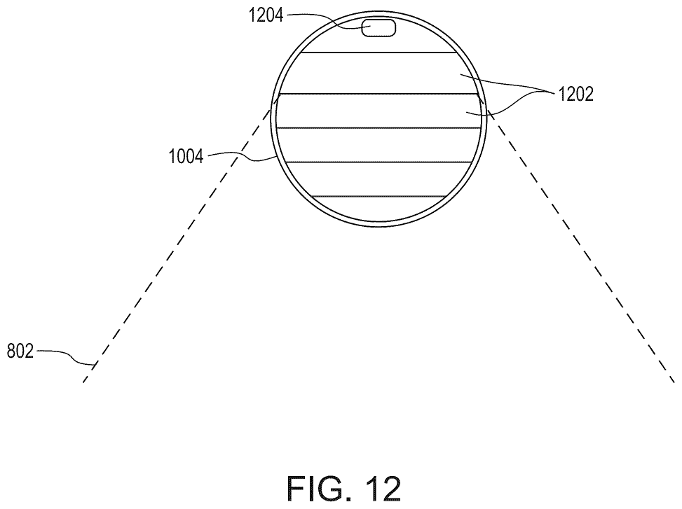

FIG. 12 is an exemplary attachment 1004 showing slats 1202 used for directing light in accordance with one aspect of the present disclosure. The slats 1202 may be made of metal, plastic, interior reflective material, or the like. Multiple sets of slats may be used. For example, one set of slats may be positioned horizontally while another set of slats are vertically. The horizontal slats may manipulate incoming light upwards or downwards. The vertical slats may be used to widen or narrow the light.

In one embodiment, the slats 1202 may be angled downwards such that light is redirected from the light source downwards. The interior portion of the slats 1202, those that are facing the light source, may direct light from the light source, taking a portion of the radiance, and bending it downwards. By doing this, the light may be intensified due to multiple beams being redirected in the same location.

In addition, and in accordance with one embodiment, the attachment 1004 may have an opening 1204 that allows further light to pass through. The light may thus be directed downwards and forwards at the same time. This allows the rider of the device to point the direction of their light into areas that would have not been otherwise.

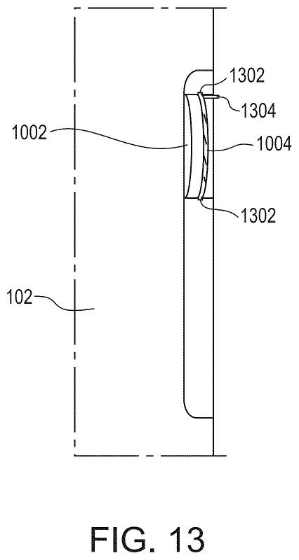

FIG. 13 is another embodiment of the attachment 1004 to direct light for the illustrative personal transport device in accordance with one aspect of the present disclosure. The attachment 1004 may be placed atop or around the light source 1002 housed within the singular modular unit 606. The light source 1002 may provide light through the attachment 1004 similar to before.

The attachment 1004 may be placed into an inlet through a channel. Fasteners 1302 may be placed on the side that hold the attachment 1004 into place. The attachment 1004 may be semi-spherical in nature and may pass and redirect incoming light. The attachment 1004 as shown before may have slats or other openings that may redirect the light that goes through.

To insert, the user may place the attachment 1004 into the modular unit. This may be performed through the use of simply pressing the attachment 1004 into the sunken light source 1002 as shown. This may slide into the fastener 1302. Once both sides are placed in, the attachment 1004 may be secured in through fasteners 1302. The fasteners 1302 may include simple divots in the side and once the attachment 1004 is in, the ends catch into the side thereby securing the attachment 1004.

To remove the attachment 1004 from the unit, the attachment 1004 may include a pullout tag 1304. The pullout tag 1304 may be coupled to one end of the attachment 1004. The attachment 1004 may be inserted through this method and extracted through it. Other methods may also exist. For example, a screw on top may be used that may be fitted over the light housing. For example, the attachment 1004 may be inserted using a threading format.

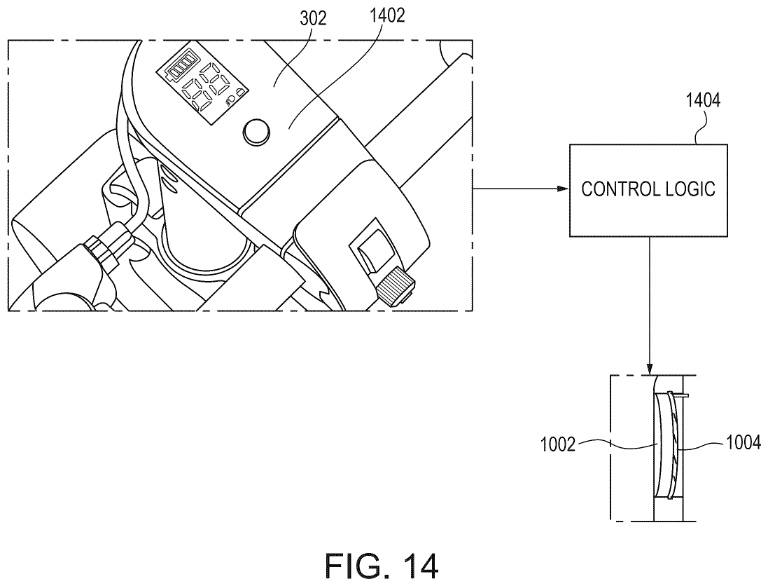

FIG. 14 is an embodiment for actuating the attachment 1004 for the illustrative personal transport device in accordance with one aspect of the present disclosure. As described before, the personal transport device may include the controller 302. On the controller 302 may include a light sensor box 1402. The box 1402 may be used to determine whether it is night or day, or whether other conditions may require lighting to be implemented.

Control logic 1404 may then be used to determine how to dispense light from a light source 1002. For example, when outside conditions are bright, the light source 1002 may be projected without alterations from the attachment 1004. Alternatively, alterations from the attachment 1004 may be used when the control logic 1404 has determined that it is dark outside.

Previously, a mechanical attachment 1004 was provided which was able to adjust the light from the light source 1002. A software implementation may also be enabled through the control logic 1404. The slats, as well as other mechanism, may be adjusted based on the light sensed from the light sensor box 1402. The slats may be angled such that more light is directed downwards. The slats may also be angled in a horizontal position such that light might be directed forwards.

Multiples sets of slats may be used. For example, vertical slats may be adjusted for adjusting the width of the projection coming out of the personal transport device. Horizontal slats may be used to point up and down, directing the light from the light source 1002. Advantageously, the light may be adjusted automatically through the control logic 1404.

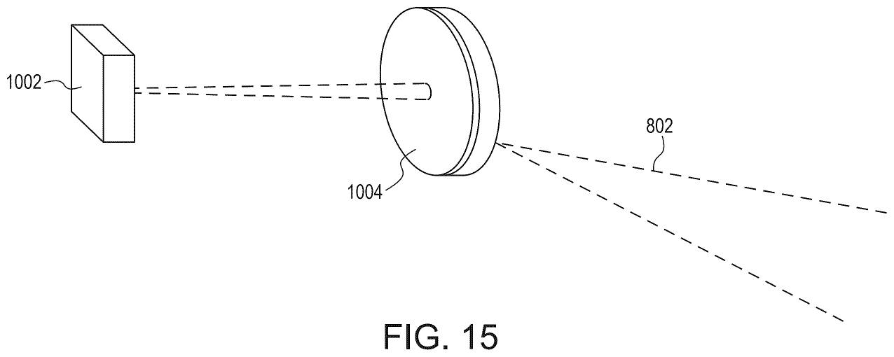

Below, are some exemplary illustrations of how light may be adjusted based on different scenarios through the attachment described above. FIG. 15 is an embodiment for altering light in a downward direction using the attachment 1004 for the illustrative personal transport device in accordance with one aspect of the present disclosure. The total system may include a singular modular unit or other like systems. Light is projected from the light source 1002 towards the attachment 1004. The light source 1002 may be turned on or off depending on the situation as well as through commands provided by the user of the personal transport device. The attachment 1004 may then angle the light downwards. This may be accomplished by angling the slats of the attachment 1004 to point downwards.

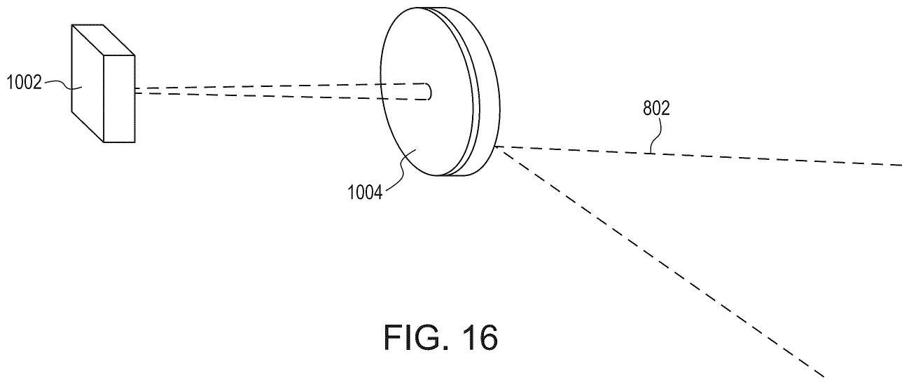

FIG. 16 is an embodiment for altering light in a wider downward direction using the attachment 1004 for the illustrative personal transport device in accordance with one aspect of the present disclosure. The light source again 1002 may provide light which is altered through the attachment 1004. Vertical slats, as opposed to horizontal slats, of the attachment 1004 may adjust the width of the projection 802.

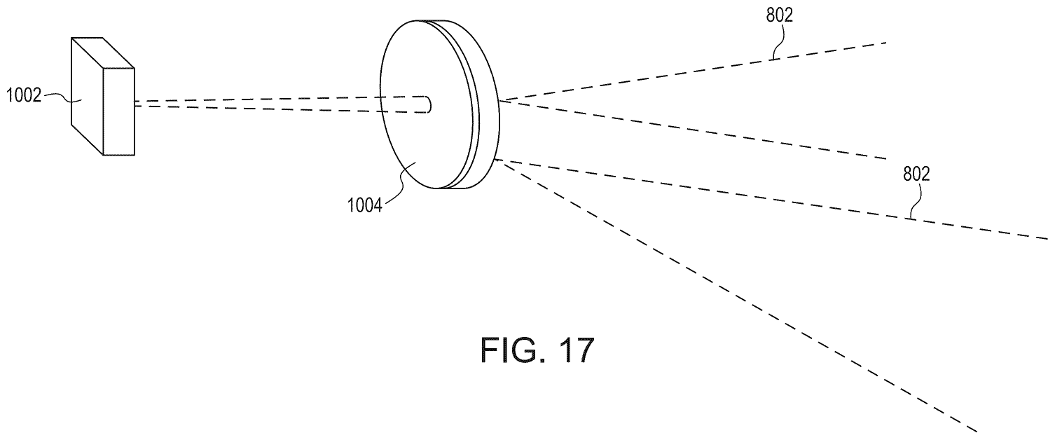

FIG. 17 is an embodiment for altering light in a forward and downward direction using the attachment 1004 for the illustrative personal transport device in accordance with one aspect of the present disclosure. The light source 1002 may provide the light beam that gets split into two projections 802 by the attachment 1004. In this embodiment, a top portion of slats on the attachment 1004 may be opened while a bottom portion of slats direct the light downwards.

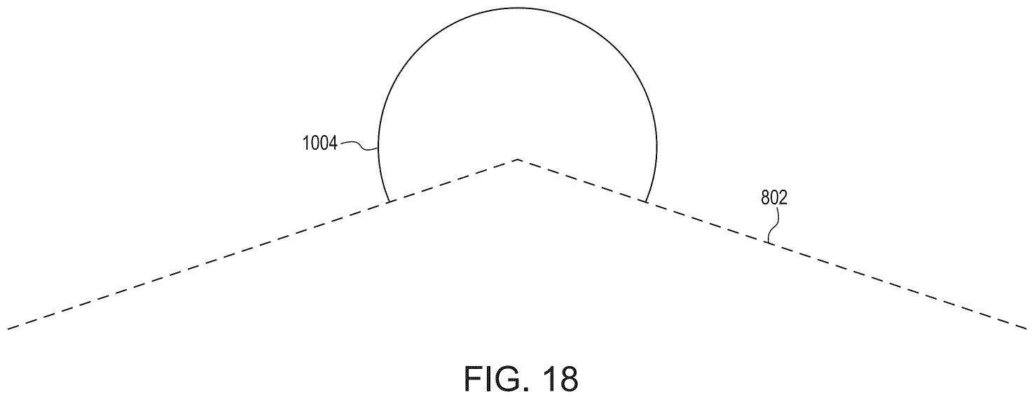

FIG. 18 is an embodiment for altering light in a downward direction using the attachment 1004 for the illustrative personal transport device in accordance with one aspect of the present disclosure. The attachment 1004 from the front perspective may increase the width of the projection 802. This may again be implemented through the use of vertical slats that direct light from the light source width wise.

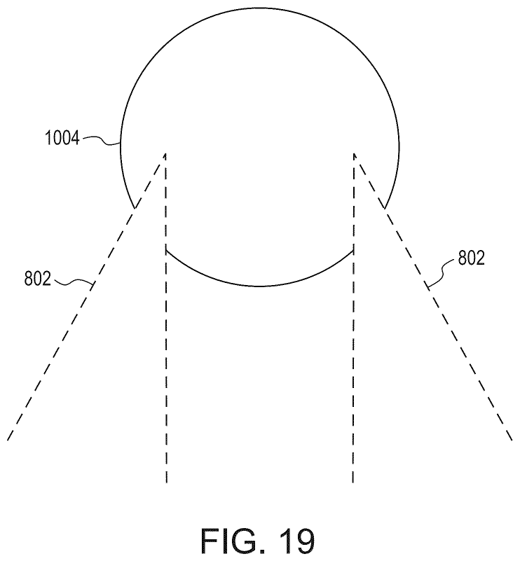

FIG. 19 is an embodiment for altering light in two downward directions using the attachment 1004 for the illustrative personal transport device in accordance with one aspect of the present disclosure. The attachment 1004 may use a combination of vertical and horizontal slats to get the desired projections 802. For example, the horizontal slats may direct all the light downwards. From there, the vertical slats may be adjusted. One half of the vertical slats may point in one direction and the other half in the other direction. This would cause the two desired projections 802 as shown.

The foregoing description is provided to enable any person skilled in the relevant art to practice the various embodiments described herein. Various modifications to these embodiments will be readily apparent to those skilled in the relevant art and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

1. A personal transport device comprising:
a casing;
a front wheel;
a rear wheel;
a steering assembly;
a light source positioned within the casing for dispensing light;
an attachment for the light source that modifies an original direction of the light; and
a light sensor configured to detect ambient light conditions and to provide input to control logic that actuates the attachment when the detected ambient light level crosses a predetermined threshold, the control logic adjusting the attachment for modifying the original direction of the light.

2. The personal transport device of claim 1, wherein the light source and the attachment are fully removable from the casing, the light source and the attachment combined in a singular modular unit.

3. The personal transport device of claim 1, wherein the original direction of the light is forward with respect to the casing.

4. The personal transport device of claim 1, wherein the light is modified to point downwards.

5. The personal transport device of claim 1, wherein the light is modified to point forwards and downwards.

6. The personal transport device of claim 1, wherein the light is modified to point into at least two downward directions.

7. The personal transport device of claim 1, wherein the light is modified into a wider beam.

8. The personal transport device of claim 1, wherein the attachment for the light source fits over the light source.

9. The personal transport device of claim 8, wherein the attachment for the light source comprises a pullout tag.

10. (canceled)

11. The personal transport device of claim 1, wherein the light source and attachment are positioned on a front of the personal transport device.

12. The personal transport device of claim 1, wherein the light source and attachment are positioned on a back of the personal transport device.

13. An attachment for a light source on a personal transport device comprising:
a circular lens;
a plurality of slats atop the circular lens for redirecting light from the light source into a downwards angle; and
a light sensor configured to detect ambient light conditions and to provide input to control logic that actuates the attachment when the detected ambient light level crosses a predetermined threshold, the control logic adjusting the attachment for modifying an original direction of the light.

14. The attachment for the light source on the personal transport device of claim 13, wherein the plurality of slats are angled in such a way as to redirect the light into the downwards angle.

15. The attachment for the light source on the personal transport device of claim 13, wherein the attachment and the light source are on a singular modular unit.

16. The attachment for the light source on the personal transport device of claim 13, wherein the attachment may be coupled atop the light source.

17. A system comprising:
a personal transport device;
an illumination system disposed within the personal transport device having a light source and an attachment for the light source; and
a light sensor configured to detect ambient light conditions and to provide input to control logic that actuate the attachment when the detected ambient light level crosses a predetermined threshold, the control logic adjusting the attachment for modifying a direction of light coming from the light source.

18. The system of claim 17, wherein the attachment cause the light to be pointed downwards.

19. The system of claim 17, wherein the attachment causes the light to increase in width.

20. The system of claim 17, wherein the light source and the attachment are in a singular modular unit.
